(19) United States
(12) Patent Application Publication
(10) Pub. No.: US 2007/0164951 A1
(43) Pub. Date: Jul. 19, 2007

(54) DISPLAY DEVICE

(75) Inventor: Koji KURITA, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd, Tokyo (JP)

(21) Appl. No.: 11/620,357

(22) Filed: Jan. 5, 2007

(30) Foreign Application Priority Data
Jan. 16, 2006 (JP) 2006-007356

(51) Int. Cl. G09G 3/36

(52) U.S. Cl. 345/87

(57) ABSTRACT

A driving circuit of a liquid crystal panel is provided to a glass substrate. A power supply IC for supplying power to the driving circuit is mounted on FPC for electrically connecting the liquid crystal panel and an image output IC at the outside of the liquid crystal panel. The liquid crystal panel can be driven by the driving circuit on the glass substrate without use of a relatively expensive driver IC for driving the liquid crystal panel, and thus the manufacturing cost can be suppressed. By providing the power supply IC on FPC, the precision of the power supply IC can be enhanced, and the display quality of the liquid crystal panel can be secured.

### INCORPORATION BY REFERENCE

The present application claims priority under 35 U.S.C. §119 to Japanese Patent Application No. 2006-007356 filed on Jan. 16, 2006. The content of the application is incorporated herein by reference in its entirety.

### FIELD OF THE INVENTION

The present invention relates to a driving circuit for driving a display panel.

### BACKGROUND OF THE INVENTION

For example, a display device such as an LCD or the like for a cellular phone includes a liquid crystal panel as a display panel equipped with an array board having a glass substrate as an insulating substrate and a counter board disposed so as to face the array board, and the liquid crystal panel is provided with an FPC (Flexible Printed Circuit) for electrically connecting the liquid crystal panel to an external image output IC or the like.

In order to drive such a liquid crystal panel, general-purpose parts such as capacitors, resistors, etc., and a driver IC constituting a driving circuit for driving liquid crystal are required, as shown, for example, in Japanese Laid-open Patent Publication No. 2004-226786. Such parts are generally mounted on the glass substrate or FPC.

However, the driver IC for driving liquid crystal is generally expensive, and thus an LCD using no driver IC has been studied.

With recent developments of the liquid crystal manufacturing process, it has been possible to form an electrical circuit having some degree of scale on a glass substrate, and thus it has been made possible to build up the function of the driver IC on the glass substrate and bring a part of the function of the driver IC on the glass substrate. If all the driver circuits of the driver IC containing a power supply circuit are formed on the glass substrate, it would be expected that the cost is greatly reduced.

However, the manufacturing process of semiconductors provided on such a glass substrate is different from that of normal semiconductors, and the amount of circuits to be built up is limited. Therefore, it is impossible to form on a glass substrate a power supply circuit, etc., which have sufficient high function and high precision to drive an LCD for a cellular phone or the like.

Furthermore, in order to realize high grade image quality required of LCDs for recent cellular phones, a high-precision power supply circuit is indispensable and thus the power supply circuit cannot be omitted.

Still furthermore, it may be considered that the driving circuits containing the power supply circuit may be placed at the outside of the LCD module. In this case, however, a large number of (one hundreds or more) terminals are required to drive the liquid crystal panel, and thus the number of input and output terminals of the FPCs which are electrically connected to these driving circuits is very large (one hundreds or more for each driving circuit).

The present invention has an object to provide a display device that can secure display quality of a display panel while suppressing the manufacturing cost thereof.

### SUMMARY OF THE INVENTION

The present invention comprises a display panel equipped with a display area having plural pixels and a driving circuit for driving the display area that are formed on the same substrate, a flexible print board that is connected to the display panel and electrically connected to the outside of the display panel, and a power supply IC that are mounted on the flexible print board and supplies power to the driving circuit. According to this invention, the display panel can be driven by the driving circuit on the display panel without use of any relatively expensive driving IC. Therefore, the manufacturing cost can be suppressed, and the precision of the power supply circuit can be enhanced by providing the power supply circuit on the board.

### BRIEF DESCRIPTION OF THE DRAWINGS

FIG. 1 is a plan view showing a display device according to an embodiment of the present invention, and

FIG. 2 is a block diagram showing the construction of the display panel of the display device.

### DETAILED DESCRIPTION OF THE PREFERRED EMBODIMENT

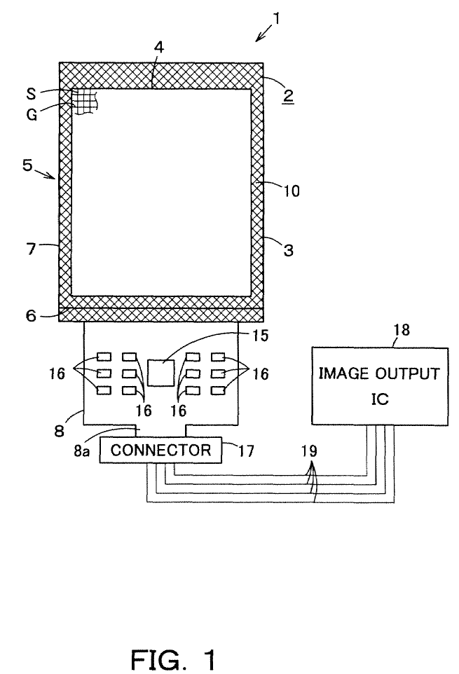

The construction of a display device according to an embodiment of the present invention will be described with reference to FIG. 1.

In FIG. 1, reference numeral 1 represents a liquid crystal display device as a display device, and the liquid crystal display device 1 has a liquid crystal panel 2 as a display panel used for a cellular phone or the like, for example. The liquid crystal panel 2 includes an array board 5 having a pixel portion 4 as a rectangular display area on one principle face corresponding to the surface of a glass substrate 3 as an insulating substrate having translucency, and a rectangular and flat-plate type counter board 6 which is slightly larger than the pixel portion 4 is disposed on the surface of the pixel portion 4 of the array board 5 so as to face the surface of the pixel portion 4. Furthermore, liquid crystal (not shown) is interposed and sealed between the array board 5 and the counter board 6. Furthermore, a backlight (not shown) as a light source is disposed on the back surface of the liquid crystal display panel 2. Scan lines G and signal lines S are disposed in a matrix form at the pixel portion 4 so as to cross each other in the longitudinal and lateral directions, and thin film transistors (TFT) and transparent pixel electrodes (ITO) (not shown) are disposed at the cross points of the scan lines G and the signal lines S.

The glass substrate 3 constitutes one side surface of the liquid crystal panel 2, and it is provided with a frame portion 7 projecting in a frame shape around the pixel portion 4 of the glass substrate 3. A flexible print board 8 (hereinafter referred to as FPC 8) is thermally press-fitted to predetermined bumps (not shown) at the one end portion of the glass substrate 3, for example, through ACF (Anisotropic Conductive Film), that is, electrically connected to the bumps by ACF connection.

A driving circuit 10 for driving the pixel portion 4 of the liquid crystal panel 2 and displaying an image is formed at the frame portion 7.

On FPC 8, a square-shaped power supply IC 15 as a power supply circuit for supplying power to the driving circuit 10 is mounted substantially at the center portion, and plural general-purpose parts 16 such as capacitors, resistors, etc., are mounted at both the sides of the power supply IC 15. Furthermore, a projecting portion 8a is provided at one end portion of FPC 8 which is located at the opposite side to the glass substrate 3, short-circuit terminals (not shown) leading out from the power supply IC 15, etc., are juxtaposed with one another on the projecting portion 8a. These short-circuit terminals are electrically connected through a connector 17 as a connecting member to wire portions 19 led out from an image output IC 18 mounted on the set board of a cellular phone (not shown) at the outside. The image output IC 18 outputs a signal for driving pixels of the pixel portion 4, etc., on the basis of image data to be displayed.

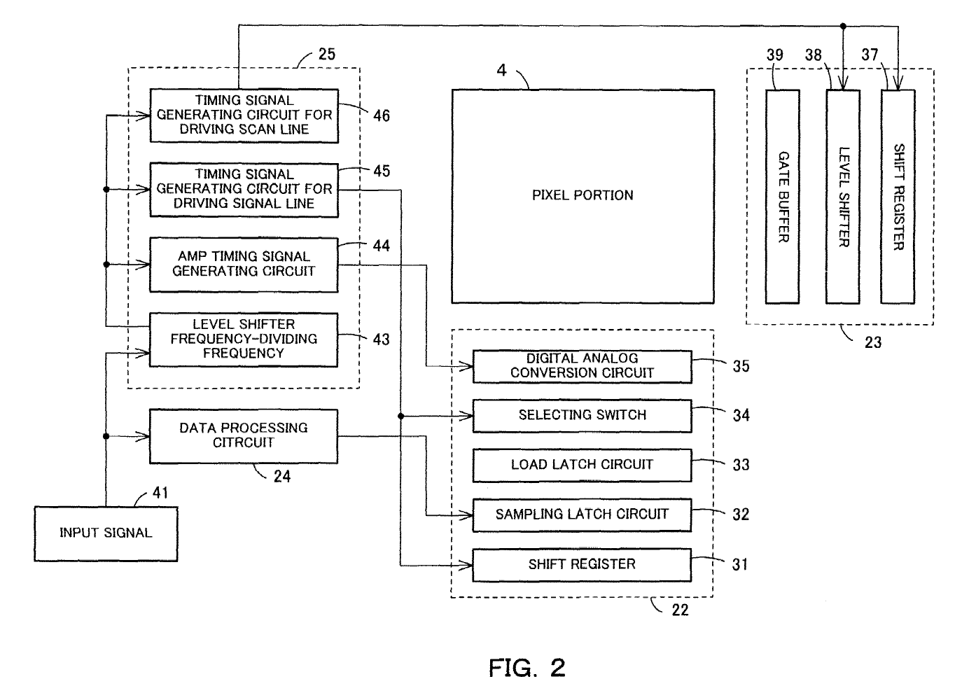

Next, the construction of the liquid crystal panel 2 will be described with reference to FIG. 2.

FIG. 2 is a block diagram showing the construction of the above liquid crystal panel 2. That is, the liquid crystal panel 2 shown in FIG. 2 is equipped with the pixel portion 4, and further equipped with the driving circuit 10 comprising circuits having relatively low precision and small power capability such as a signal line driving circuit 22 that is electrically connected to the signal lines S of the pixel portion 4 and supplies a video signal, a scan line driving circuit 23 that is electrically connected to the scan lines G of the pixel portion 4 and drives the scan lines G, a data processing circuit 24, and a clock generating circuit 25, and the liquid crystal panel 2 is designed as a driving circuit integrated type display panel in which the pixel portion 4 and the driving circuit 10 are integrated on the glass substrate 3.

The pixel portion 4 has the thin film transistors at the cross points of the signal lines S and the scan lines G arranged in a matrix form, and an electric field is applied to the liquid crystal by conducting the thin film transistors, thereby displaying an image.

The signal line driving circuit 22 is equipped with a shift register 31, a sampling latch circuit 32 for latching an input video signal, a load latch circuit 33 for latching the video signals successively latched by the sampling latch at the same timing, a selection switch 34 for selecting a video signal latched by the load latch circuit 33, and a digital analog conversion circuit 35 for converting the video signal selected by the selection switch 34 to an analog signal.

The scan line driving circuit 23 is equipped with a shift register 37, a level shifter 38 for subjecting an input scan line signal to voltage conversion, and a gate buffer 39 for inputting the signal voltage-converted in the level shifter 38 to the scan lines G.

The data processing circuit 24 latches RGB data of an input signal 41 input from the image output IC 18 through the wire portion 19 and the connector 17, and subjects the RGB data to serial-parallel conversion, and also outputs the converted data as a video signal to the signal line driving circuit 22.

The clock generating circuit 25 generates various kinds of timing signals, and outputs these signals to the signal line driving circuit 22, the scan line driving circuit 23, etc. That is, the clock generating circuit 25 comprises a level shifter frequency-dividing circuit 43 for dividing the voltage of the input signal 41 by voltage conversion, an AMP timing signal generating circuit 44 for generating a clock signal on the basis of a signal which is frequency-divided by the level shifter frequency-dividing circuit 43 and outputting the clock signal to the digital-analog conversion circuit 35, etc., a signal line driving timing signal generating circuit 45 for generating a clock signal on the basis of the signal frequency-divided by the level shifter frequency-dividing circuit 43 and outputting the clock signal to the shift register 31, the selection switch 34, etc., and a scan line driving timing signal generating circuit 46 for generating a clock signal on the basis of the signal frequency-divided by the level shifter frequency-dividing circuit 43 and outputting the signal to a shift register 37, a level shifter 38, etc.

Next, the operation of the first embodiment described above will be described.

When the liquid crystal display device 1 is manufactured, the counter board 6 having a counter electrode, etc., is disposed so as to face the glass substrate 3 having the predetermined driving circuit 10, the thin film transistors, the pixel electrodes, etc., formed thereon.

Subsequently, FPC 8 having the power supply IC 15 and the general-purpose parts 16 mounted thereon is electrically connected to the glass substrate 3 by AFC or the like.

Furthermore, the short-circuit terminals formed on the FPC 8 are electrically connected through the connector 17 to the wire portion 19 lead out from the image output IC 18 mounted on the set board of a cellular phone.

The power supply IC 15 of FPC 8 outputs a predetermined power supply signal to the driving circuit 10 on the basis of a signal which is transmitted from the image output IC 18 to the wire portion 19 and the connector 17 on the basis of desired image data to be displayed.

When the input signal 41 is input to the data processing circuit 24 and the clock generating circuit 25 in the driving circuit 10, the input RGB data are latched, subjected to serial-parallel conversion and then output as a video signal to the signal line driving circuit 22 in the data processing circuit 24.

Furthermore, various kinds of timing signals are generated on the basis of the input signal 41 in the respective signal generating circuits 44, 45 and 46 of the clock generating circuit 25, and output to the signal line driving circuit 22 and the scan line driving circuit 23.

The video signal input to the signal line driving circuit 22 is latched by the sampling latch circuit 32 on the basis of the clock signal input from the clock generating circuit 25 by the timing signal generated by the shift register 31.

The load latch circuit 33 latches video signals successively latched by the sampling latch circuit 32 at the same timing, and the selection switch 34 selects a video signal.

The selected video signal is converted to an analog signal by the digital-analog conversion circuit 35, and the analog signal concerned is amplified till it has a voltage for driving the liquid crystal and output to the pixel portion 4.

In the scan line driving circuit 23, the clock signal generated by the clock generating circuit 25 is input to the shift register 37 to control the scan line signal for selecting the scan line G. The scan line signal is subjected to voltage conversion in the level shifter 38, and applied to the scan line G through the gate buffer 39.

In the pixel portion 4, when the scan line signal of the scan line G is given, the video signal applied to the signal line S is written into the pixel electrode and the electric field is applied to the liquid crystal.

As a result, the pixel of the pixel portion 4 is turned on/off and thus the image corresponding to the desired image data is displayed on the pixel portion 4.

As described above, in the above-described embodiment, the driving circuit 10 of the liquid crystal panel 2 is provided to the glass substrate 3, and the power supply IC 15 for supplying power to the driving circuit 10 is mounted on FPC 8 which is electrically connected to the liquid crystal panel 2 and the external image output IC 18 of the liquid crystal panel 2.

That is, in the above-described embodiment the driving circuit 10 having the driver IC function such as the gate driving portion, the source driving portion, a simple voltage increasing power supply circuit, etc., which do not need precision and current capability is formed on the glass substrate 3, and only the power supply IC 15 requiring high precision and high capability is mounted on FPC 8.

As a result, the liquid crystal panel 2 can be driven by the driving circuit 10 on the glass substrate 3 without use of any relatively expensive driver IC for driving the liquid crystal panel 2, and thus the manufacturing cost can be suppressed. In addition, the power supply IC 15 is not provided to the glass substrate 3 on which the precision and capacitance of circuits formable on the glass substrate 3 are restricted, but provided to FPC 8. Therefore, the power supply IC 15 having enhanced precision can be mounted on FPC 8. Therefore, the display quality of the liquid crystal panel 2 can be secured by the driving circuit 10 controlled by the power supply IC 15 having the enhanced precision. Therefore, this liquid crystal panel 2 can be designed as a high-performance one having the same level performance as LCD for a cellular phone, and the liquid crystal panel 2 having sufficient performance for a cellular phone can be implemented.

In addition, the power supply IC 15 is cheaper than the driver IC, and thus even when the power supply IC is mounted on FPC 8, the cost can be suppressed to a value less than a case where the driver IC and the power supply IC are mounted on a substrate such as an FPC or the like.

Furthermore, in a conventional case where the driver IC and the power supply circuit are disposed on the set board of the cellular phone, that is, at the outside of the glass substrate 3 and FPC 8, the signal lines S and the power supply lines are connected from the driver IC side to FPC 8 and the glass substrate 3 side. Therefore, the number of input terminals is increased to 100 or more, for example. Therefore, the connection requires a significant amount of labor, the manufacturing cost is increased, and some problem occurs in reliability of the connection or the size of the connector 17 is increased needlessly. On the other hand, according to the embodiment of the present invention, by mounting the power supply IC 15 on FPC 8, the number of input terminals of the connector can be suppressed to about 30, for example, and the problem that the number of input terminals is increased can be solved.

Furthermore, the driver IC and the power supply IC 15 are not disposed on the glass substrate 3, and thus the size of the frame portion 7 can be reduced, the pixel portion 4 can be expanded and the whole size of the device can be miniaturized.

The above-described embodiment may be applied not only to the liquid crystal display device 1, but also to a display device such as an organic EL display device or the like, for example.

What is claimed is:

1. A display device comprising:
a display panel equipped with a display area having plural pixels and a driving circuit for driving the display area that are formed on the same substrate;
a flexible print board that is connected to the display panel and electrically connected to the outside of the display panel; and
a power supply IC that is mounted on the flexible print board and supplies power to the driving circuit.

2. The display device according to claim 1, wherein the display area has signal lines and scan lines, and the driving circuit comprises a signal line driving circuit for driving the signal lines, a scan line driving circuit for driving the scan lines, a data processing circuit for processing an input signal, and a clock generating circuit for generating a clock signal on the basis of the input signal.
